(19) United States
(12) Patent Application Publication
(10) Pub. No.: US 2004/0180805 A1
(43) Pub. Date: Sep. 16, 2004

(54) Detergent compositions

(75) Inventors: Raquel Beatriz Barchini, Vlaardingen (NL); Philippus Cornelis van der Hoeven, Vlaardingen (NL); Willem Bernard Stanislaus van Liemt, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/763,930

(22) Filed: Jan. 23, 2004

(30) Foreign Application Priority Data
Jan. 27, 2003 (GB) 0301849.6
Feb. 5, 2003 (GB) 0302663.0

(51) Int. Cl. C11D 17/00

(52) U.S. Cl. 510/424

(57) ABSTRACT

A detergent composition comprising from 0.01% to 99.9% by weight of an aromaticalkyl sulphonic surfactant, the balance being one or more other ingredients.

### TECHNICAL FIELD

This invention relates to detergent compositions comprising an anionic surfactant which contains both an alkyl moiety and an aryl moiety.

### BACKGROUND TO THE INVENTION

The most common anionic surfactants in laundry wash compositions are linear alkyl benzene sulphonic acids (LAS), although “linear” is somewhat of a misnomer since the benzene group (which is sulphonated) is almost never attached to the terminal atom of the alkyl chain.

Recently, there has been interest in LAS analogues in which the alkyl chain is branched part way along the length thereof, such as disclosed in WO-A-99/05082, WO-A-99/05084, WO-A-99/05241, WO-A-99/05242, WO-A-99/05243, WO-A-99/05244 and WO-A-99/07656.

U.S. Pat. No. 6,043,391 discloses certain aromaticalkyl anionic surfactants and their use in oil recovery. These compounds comprise a sulphonated or straight or branched C₇-C₃₀ alkyl group attached to an aromatic group, which optionally may be benzene. The examples are based on non-solid compositions containing dialkyl benzene sulphonates in combination with branched monoalkyl benzene sulphonate, isopropanol and ethylene glycol.

We have now found that detergency in terms of removal of certain classes of soil such as fatty/oily/greasy soils and/or one or more other advantages such as improved solubility at low temperatures, faster foaming, higher calcium tolerance, improved solubilisation of cosurfactants, improved rinsability, and better skin mildness, can be achieved in laundry cleaning detergent compositions by including in them, an aromaticalkyl sulphonic surfactant.

### DEFINITION OF THE INVENTION

In a first aspect, the present invention provides a detergent composition comprising from 0.01% to 99.9% by weight of an aromaticalkyl sulphonic surfactant, the balance being one or more other ingredients, for example selected from any class, sub-class or individual ingredients recited herein.

A second aspect of the present invention provides a composition according to the first aspect of the present invention with the provisos that

(a) if the composition is a solid, then if it is a powder, it comprises a further surfactant in addition to the aromaticalkyl sulphonic surfactant(s) and other than a 10 mole ethoxylate of nonylphenol (preferably other than any nonylphenol ethoxylate);and

(b) if the composition is a non-solid then either

(1) it is substantially non-aqueous, preferably comprising 23% or less, more preferably 22% or less, still more preferably 20% or less, yet more preferably 15% or less, even more preferably 10% or less, especially 5% or less, 2% or less, or 1% or less by weight of water, eg substantially free from or completely free from water; or

(2) it is substantially aqueous and

(i) is substantially free from, or contains a hydrotrope additional to, sodium xylene sulphonate;

(ii) it is substantially free from, or contains an organic solvent additional to, the group consisting of ethanol and propylene glycol; and

(iii) has a pH≧6.5, preferably ≧7.

In this context, substantially aqueous means having more water than a substantially non-aqueous composition, for example preferably comprising at least 1%, more than 2%, more than 5%, preferably more than 10%, more preferably more than 15%, still more preferably more than 20%, yet more preferably more than 22%, most preferably more than 23% by weight of water.

Optionally, compositions according to the second aspect of the present invention are preferably substantially free from any one or more of propylene glycol, propylene glycol n-butyl ether and isopropanol. Optionally, they are also substantially free from sodium metasilicate.

As used herein, the term “solid composition” includes powders (including granulates) and tablets, and encapsulated variants of any of these. The term excludes non-solids such as pastes, gels or liquids.

In a third aspect of the invention, the balance of one or more other ingredients in the composition of the first or second aspect of the invention comprises at least one such ingredient other than:

(a) a surfactant selected from cocoalkanolamides and modified forms thereof, cocamidopropyl betaine and a 9 or 10 mole ethoxylate of nonylphenol; and

(b) an organic solvent selected from ethanol, isopropanol or ethylene glycol.

The exclusions in the third aspect of the present invention mean that although optionally, any of the materials recited in (a) and (b) may be present, at least one other ingredient must be present in any composition according to that aspect of the invention. Other such ingredients are preferably chosen from the members of those classes of materials which are beneficial in laundry wash products. A non-exhaustive list of these classes comprises cosurfactants, detergency builders, enzymes, bleaches, bleach systems or components thereof, anti-corrosive agents, alkali buffers, anti-foams, foam boosters, anti-redeposition and soil-suspending agents, anti-redeposition agents, softening agents such as cationic surfactants, clays, softening polymers such as those containing a polysaccharide and/or a cationic polymer moiety, anti-crease and ease of ironing aids, anti-dye transfer agents and dye fixatives.

Another aspect of the present invention provides a detergent composition according to the first aspect of the present invention, further comprising at least one surfactant other than any of dialkylbenzene sulphonate, a branched monoalkylbenzene, sulphonic acid or its sodium salt, a cocoalkanolamide or modified form thereof, a cocamidopropyl betaine and a 9 or 10 mole ethoxylate of nonylphenol.

Another aspect of the present invention provides a detergent composition according to the first aspect of the present invention wherein the aromaticalkyl sulphonic surfactant comprises an aromaticmono-alkyl sulphonic system wherein the aromatic ring or ring system is optionally substituted by one or more other substituents, eg as expressed elsewhere in this specification, and the composition further comprises another surfactant other than any of a cocoalkanolamide or modified form thereof, a cocamidopropyl betaine and an ethoxylate of nonylphenol.

Other aspects of the present invention include a composition according to any other aspect of the present invention expressed herein, wherein the composition is substantially free from any one or more ingredients selected from those defined in classes (a) and (b) defined in the second or third aspect of the present invention. As used herein, “substantially free from” means for each such ingredient, that the composition comprises less than 10%, preferably less than 5%, more preferably less than 1%, still more preferably less than 0.5%, especially less than 0.1% by weight of that ingredient or is totally devoid of that ingredient.

Yet other aspects of the present invention include any composition according to any other aspect of the present invention expressed herein, wherein the composition is substantially free from one or more other ingredients selected from any class, sub-class or individual ingredients recited herein.

For example, a composition according to the present invention may be substantially free from or contain a surfactant additional to any one or more or all of those in the group consisting of dialkyl benzene sulphonate (eg. having the composition of Example 3 in U.S. Pat. No. 6,043,391), branched monoalkylbenzene sulphonic acid or a salt thereof, modified cocoalkanolamide (eg. Ninol 11-CM™), nonylphenolamole ethoxylate, nonylphenol 10 mole ethoxylate, nonylphenol 12 mole ethoxylate (or any nonylphenol ethoxylate), lauramine oxide, C₁₄-C₁₈ alpha olefin sulphonate (eg. BIO-TERGE AS-40™) (or any alpha olefin sulphonate), sodium laureth sulphate with 3 moles of ethylene oxide (eg STEOL CS-460™) (eg.STEOL CS-320™) (or any alkyl ether sulphate), a mixture of sodium alpha-sulpho methyl C₁₂-C₁₈ ester and sodium-alpha sulpho-C₁₂-C₁₈ fatty acid salt (eg. ALPHA-STEP MC-48™) and cocamidopropyl betaine, diethanolamine cocamide (eg. NINOL 40-CO™). Any reference to such materials which can exist in salt (eg. with an organic or inorganic, such as sodium, ion) or else in acid form may optionally be expressed as either. The Trade Marks recited in this paragraph are Trade Marks of the Stepan Company.

Another aspect of the present invention provides a detergent composition comprising an aromaticalkyl sulphonic surfactant not obtained by alkylating an aromatic compound with an alkyl olefin sulphonate in the presence of a super acid catalyst under substantially anhydrous conditions, the composition comprising least one additional ingredient selected from nonionic surfactants, cationic surfactants, amphoteric surfactants, zwitterionic surfactants, detergency builders, bleaches, enzymes, polymers, perfumes and fluorescers.

A further aspect of the present invention provides a detergent composition according to the first aspect of the present invention, wherein the aromaticalkyl sulphonic surfactant comprises a C₁₄-C₁₆ aromaticalkyl sulphonic surfactant, preferably wherein the aryl moiety is benzene, optionally substituted by one or two C₁-₄ alkyl (most preferably methyl) groups.

The present invention also encompasses use of a composition according to any aspect of the invention-in a method of washing a textile fabric by contacting the fabric with said composition, preferably in an aqueous wash liquor.

### DETAILED DESCRIPTION OF THE INVENTION

The compositions according to the present invention must contain from 0.01% to 99.9% by weight of an aromaticalkyl sulphonic surfactant and at least one other ingredient.

The Aromaticalkyl Sulphonic Surfactant

As used herein, the term “aromaticalkyl sulphonic surfactant” excludes materials such as alkyl benzene sulphonic acid or sulphonate wherein the sulphonic acid or sulphonate group is attached to the benzene ring or other aromatic ring or ring system but instead is intended to refer to molecules wherein the sulphonic acid or sulphonate group is attached to the alkyl chain.

The aromaticalkyl sulphonic surfactant may be in the form of the aromaticalkyl sulphonic acid (AASA), ie the free acid form or in the form of a salt thereof, preferably an alkalimetal salt such as the sodium or potassium salt, or salt of an organic cation such as an amine, eg monoethanolamine.

In the definition of the invention as claimed herein, the term “aromaticalkyl sulphonic surfactant” and reference to its free acid and salt forms includes both a single chemical entity falling within any of these definitions or a mixture of such entities.

The “sulphonated alkyl” moiety (ies) appearing in the name of the aromaticalkyl sulphonic surfactants mean that the aromatic ring or ring system is substituted by one or more independently selected alkyl groups, at least one of which must be sulphonated. Especially preferred is mono-substitution by one sulphonated alkyl group. Also preferred is di-substitution by independently selected alkyl groups, either or both being sulphonated. Other optional substituents on the aromatic ring or ring system are mentioned below.

Preferred aromaticalkyl surfactants are those wherein the aromaticalkyl sulphonic surfactant is selected from those wherein:

i) the aromatic compound is selected from unsubstituted, mono-substituted or poly-substituted (e.g. di-substituted) monocyclic or polycyclic (e.g. bicyclic) aromatic compounds, preferably selected from benzene and naphthalene, each optional substituent preferably being selected from alkyl (preferably C₁-C₄ alkyl), (poly)alkoxylated alkyl (preferably C₁-C₄ alkyl) and —OH; and

ii) the or each sulfonated alkyl group attached to the aromatic compound comprises an alkyl group selected from the group consisting of linear or branched alkyl groups of 7 to 30 carbon atoms, preferably from 8 to 24, more preferably from 9 to 20, still more preferably from 12 to 18, and most preferably from 14 to 16 carbon atoms and any non-sulphonated alkyl group also having a number of carbon atoms within any of these ranges; and.

iii) the or each sulphonic acid or sulphonate group is preferably a substituent on a terminal carbon atom of the alkyl chain (in the case of a straight alkyl chain) or on the terminal carbon atom of any main chain or any branch (i.e. the case of a branched alkyl chain).

iv) the aromatic compound may be limited by the proviso that the aromatic compound is other than phenyl or napthalene.

Preferably any group attached to each optional substituent in any mono- or poly- (eg di-) substituted aromatic compound is selected from linear and branched chain alkyl groups of 1 to 40, preferably 1 to 30, more preferably from 1 to 20, still more preferably from 1 to 10, most preferably from 1 to 4 carbon atoms.

Any alkoxy group(s) substituted optionally incorporated in any alkyl substituent on said aromatic compound are independently selected from ethylene oxide, propylene oxide, butylene oxide, and combinations of two or more thereof, where the number of alkoxylate groups range from 1 to 100.

For the avoidance of doubt, wherever a range of carbon atom chain lengths (Cₓ-C_{y}) is used for a straight or branched alkyl or alkenyl chain of a surfactant hydrophobe for any surfactant, in the broadest sense it means that the maximum in the distribution of chain lengths resides somewhere in the range from x to y. However, for an aromaticalkyl surfactant preferably it means that at least 60 mole %, more preferably at least 70 mole % of the surfactant has a chain having from x carbon atoms to y carbon atoms. For any other surfactant, it means that preferably at least 50 mole %, more preferably at least 60 mole % of the surfactant has a chain having from x carbon atoms to y carbon atoms.

Preferred aromaticalkyl sulphonic surfactants are selected from one or more compounds of formula (I):

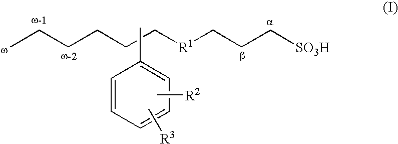

wherein R¹ is selected from straight and branched alkylene linkages having from 0 to 30, preferably from 1 to 20, more preferably from 2 to 15, still more preferably from 3 to 10, and most preferably from 5 to 7 carbon atoms. R² and R³ are independently hydrogen or methyl and preferably, the benzene ring is substituted to a substantial extent, eg up to 30 mole %, or up to 35% mole % or up to 40 mole % in the ω-1 or ω-2 position;

and/or salts thereof.

Some preferred compositions according to the present invention may contain from 0.1% to 65%, preferably from 2% to 30%, more preferably from 3% to 20%, especially from 4% to 15% by weight of the aromaticalkyl sulphonic surfactant.

Preparation of the Aromaticalkyl Sulphonic Surfactant

The aromaticalkyl sulphonic surfactant can be prepared in its free acid form by the process described in Berger, P. D., et al., “New Anionic Aromaticalkyl Sufactants Based on Olefin Sulfonic Acids”, J. Surf. and Dets., Vol. 5, No. 1 (January 2002), pp 39-43. This involves reacting the optionally substituted aryl moiety with the appropriate alpha olefin sulphonate. The corresponding salt forms are, of course, prepared by reacting the product with an appropriate base.

The Balance of Other Ingredients

The compositions according to the present invention may contain one or more additional ingredients selected from a wide range of possible classes, sub-classes and individual ingredients and in wide ranges of amount, except where specifically prohibited by specific exclusion in the definition of that aspect of the invention.

Cosurfactants

Compositions according to the invention may contain not only the aromaticalkyl surfactant but potentially any one or more other surface-active compound (surfactant) which may be chosen from soap and non-soap anionic, cationic, non-ionic, amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch.

The preferred additional detergent-active compounds that can be used are soaps and synthetic non-soap anionic, nonionic and cationic surfactants. Some examples of each of these will now be described.

Other Anionic Surfactant

In addition to the aromaticalkyl sulphonic surfactant, at least one other anionic co-surfactant is preferably also present. It may for example be selected from one or more of alkylbenzene sulphonates, alkyl sulphonates, primary and secondary alkyl sulphates (in free acid and/or salt forms). The aromaticalkyl sulphonic surfactant preferably constitutes from 0.5% to 99.9%, preferably from 1% to 80%, more preferably from 10% to 60%, especially from 15% to 50%, more especially from 25% to 45% by weight of the total anionic surfactant content of the composition.

A composition according to the present invention may, for example contain from 0.1% to 70%, preferably from 1% to 40%, more preferably from 2% to 30%, especially from 3% to 20% of alkylbenzene sulphonic surfactant (in free acid and/or salt form).

When it is desired further to enhance calcium intolerance, then any anionic surfactant in the composition which is additional to the aromaticalkyl surfactant, may comprise (preferably at a level of 70 wt % or more of the total anionic surfactant) or consist only of one or more calcium-tolerant non-soap anionic surfactants.

As referred to herein, a “calcium tolerant” anionic surfactant is one that does not precipitate at a surfactant concentration of 0.4 g/l (and at an ionic strength of a 0.040 M 1:1 salt solution) with a calcium concentration up to 20° FH (French hardness degrees), i.e. 200 ppm calcium carbonate.

A preferred additional class of non-soap calcium tolerant anionic surfactants for use in the compositions of the present invention comprises the alpha-olefin sulphonate.

Another preferred class on calcium tolerant anionic surfactants comprise the mid-chain branched materials disclosed in WO-A-97/39087, WO-A-97/39088, WO-A-97/39089, WO-A-97/39090, WO-A-98/23712, WO-A-99/19428, WO-A-99/19430, WO-A-99/19436, WO-A-99/19437, WO-A-99/19455, WO-A-99/20722, WO-A-99/05082, WO-A-99/05084, WO-A-99/05241, WO-A-99/05242, WO-A-99/05243, WO-A-99/05244 and WO-A-99/07656.

Yet another suitable class of calcium tolerant anionic surfactants comprises the alkyl ether sulphates (ie the (poly)alkoxylated alkyl sulphates).

Another suitable calcium tolerant anionic surfactants to be used in combination comprises alpha-olefin sulphonate and alkyl ether sulphate in a weight ratio of from 5:1 to 1:15.

Other calcium-tolerant anionic surfactants that may be used are alkyl ethoxy carboxylate surfactants (for example, Neodox (Trade Mark) ex Shell), fatty acid ester sulphonates (for example, FAES MC-48 and ML-40 ex Stepan), alkyl xylene or toluene sulphonates, dialkyl sulphosuccinates, alkyl amide sulphates, sorpholipids, alkyl glycoside sulphates and alkali metal (e.g. sodium) salts of saturated or unsaturated fatty acids.

Yet other suitable anionic surfactants in addition to the calcium tolerant anionics are well-known to those skilled in the art. Examples include primary and secondary alkyl sulphates, particularly C₈-C₁₅ primary alkyl sulphates; and dialkyl sulphosuccinates. Sodium salts are generally preferred.

Soaps

Optionally, a soap may also be present. Suitable soaps include those having a chain length ranging from C₁₂ to C₂₀, mainly saturated, and optionally containing limited levels of 1 or 2 unsaturated bonds, and derived from natural oils and fats such as for example: (hardened or non-hardened) Tallow, Coconut, or Palm Kernel.

In a solid formulation, the amount of optional soap is preferably from 0.1% to 10%, more preferably from 0.1% to 5% by weight of the composition. In liquid compositions, the level of optional soap is preferably from 0.1% to 20%, more preferably from 5% to 15% by weight of the composition.

Optional Other Surfactants

Optional other surfactants include nonionic surfactants, cationic surfactants (for detergency enhancement and/or fabric softening), amphoteric and zwitterionic surfactants.

If desired, nonionic surfactant may also be included. The amount of these materials, in total, is preferably from 0.01% to 50%, preferably from 0.1% to 35%, more preferably from 0.5% to 25%, still more preferably from 0.7% to 20%, even more preferably from 0.8% to 15%, especially from 1% to 10% and even more especially from 1% to 7% by weight of the composition.

Preferred nonionic surfactants are aliphatic alcohols having an average degree of ethoxylation of from 2 to 12, more preferably from 3 to 10. Preferably, the aliphatic alcohols are C₈-C₁₆, more preferably C₁₀-C₁₅.

The mid-chain branched hydrophobe nonionics disclosed in WO-A-98/23712 are another class of suitable nonionic surfactants.

Suitable other non-ethoxylated nonionic surfactants include alkylpolyglycosides, glycerol monoethers, and polyhydroxyamides (glucamide).

Optionally, a composition according to the present invention may comprise from 0.05% to 10%, preferably from 0.1% to 5%, more preferably from 0.25% to 2.5%, especially from 0.5% to 1% by weight of cationic surfactant.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surfactants Science Series” volume 34 ed. Richmond 1990, volume 37 ed. Rubingh 1991 and volume 53 eds. Cross and Singer 1994, Marcel Dekker Inc. New York”.

It is also possible to include certain mono-alkyl cationic surfactants which can be used for their detergency. Cationic surfactants that may be used for this purpose include quaternary ammonium salts of the general formula R₁R₂R₃R₄N⁺ X⁻ wherein the R groups are long or short hydrocarbon chains, typically alkyl, hydroxyalkyl or ethoxylated alkyl groups, and X is a counter-ion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

Detergency Builders

The compositions of the invention, when used as laundry wash compositions, will quite often also contain one or more detergency builders. The total amount of detergency builder in the compositions will typically range from 1% to 80 wt %, preferably from 2% to 60 wt %, more preferably from 4% to 30% by weight of the total composition.

Inorganic builders that may be present include sodium carbonate, if desired in combination with a crystallisation seed for calcium carbonate, as disclosed in GB-A-1 437 950; crystalline and amorphous aluminosilicates, for example, zeolites as disclosed in GB-A-1 473 201, amorphous aluminosilicates as disclosed in GB-A-1 473 202 and mixed crystalline/amorphous aluminosilicates as disclosed in GB-A-1 470 250; and layered silicates as disclosed in EP-A-164 514. Inorganic phosphate builders, for example, sodium orthophosphate, sodium pyrophosphate and sodium tripolyphosphate (STP) are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 20 to 50 wt %.

When the aluminosilicate is zeolite, preferably the maximum amount is 30% by weight.

The alkali metal aluminosilicate may be either crystalline or amorphous or mixtures thereof, having the general formula: 0.8-1.5 Na₂O. Al₂O₃. 0.8-6 SiO₂.

These materials contain some bound water and are required to have a calcium ion exchange capacity of at least 50 mg Ca/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB-A-1 429 143. The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP-A-384 070. Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred is zeolite MAP having a silicon to aluminium ratio not exceeding 1.07, more preferably about 1.00. The calcium binding capacity of zeolite MAP is generally equivalent to at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di and trisuccinates, carboxymethyloxy succinates, carboxymethyloxymalonates, dipicolinates, hydroxyethyliminodiacetates, alkyl- and alkenylmalonates and succinates; and sulphonated fatty acid salts. This list is not intended to be exhaustive.

Especially preferred organic builders are citrates, suitably used in amounts of from 2 to 30 wt %, preferably from 5 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form.

Bleaches

Laundry wash compositions according to the invention may also suitably contain a bleach system. Fabric washing compositions may desirably contain peroxygen bleaching agents and precursors thereof, for example, inorganic persalts or organic peroxyacids, capable of yielding hydrogen peroxide in aqueous solution.

Peroxygen bleaching agents include those peroxygen bleaching compounds which are capable of yielding hydrogen peroxide in an aqueous solution. These compounds are well known in the art and include hydrogen peroxide and the alkali metal peroxides, organic peroxide bleaching compounds such as urea peroxide, and inorganic persalt bleaching compounds, such as the alkali metal perborates, percarbonates, perphosphates, and the like. Mixtures of two or more such compounds may also be suitable.

Preferred peroxygen bleaching agents include peroxygen bleach selected from the group consisting of perborates, percarbonates, peroxyhydrates, peroxides, persulfates, and mixtures thereof. Specific preferred examples include: sodium perborate, commercially available in the form of mono- and tetra-hydrates, sodium carbonate peroxyhydrate, sodium pyrophosphate peroxyhydrate, urea peroxyhydrate, and sodium peroxide. Particular preferred are sodium perborate tetrahydrate, and especially, sodium perborate monohydrate. Sodium perborate monohydrate is especially preferred because it is very stable during storage and yet still dissolves very quickly in the bleaching solution. Sodium percarbonate may also be preferred for environmental reasons.

The amount thereof in the composition of the invention usually will be within the range of about 1-35% by weight, preferably from 5-25% by weight. One skilled in the art will appreciate that these amounts may be reduced in the presence of a bleach precursor e.g., N,N,N′N′-tetraacetyl ethylene diamine (TAED).

Another suitable hydrogen peroxide generating system is a combination of a C1-C4 alkanol oxidase and a C1-C4 alkanol, especially a combination of methanol oxidase (MOX) and ethanol or glucose oxidase (GOX) and glucose. Such combinations are disclosed in International Application PCT/EP 94/03003 and WO9856885 (Unilever), which is incorporated herein by reference.

Alkylhydroperoxides are another class of peroxy bleaching compounds. Examples of these materials include cumene hydroperoxide, t-butylhydroperoxide and hydroperoxides originated from unsaturated compounds, such as unsaturated soaps

Further, useful compounds as oxygen bleaches include superoxide salts, such as potassium superoxide, or peroxide salts, such as disodiumperoxide, calcium peroxide or magnesium peroxide.

Organic peroxyacids may also be suitable as the peroxy bleaching compound. Such materials normally have the general formula:

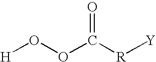

wherein R is an alkylene or substituted alkylene group containing from 1 to about 20 carbon atoms, optionally having an internal amide linkage; or a phenylene or substituted phenylene group; and Y is hydrogen, halogen, alkyl, aryl, an imido-aromatic or non-aromatic group, a COOH or

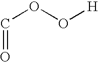

group (giving di(peroxyacids)) or a quaternary ammonium group.

Typical monoperoxy acids useful herein include, for example:

(i) peroxybenzoic acid and ring-substituted peroxybenzoic acids, e.g. peroxy-.alpha.-naphthoic acid or m-chloroperoxybenzoic acid

(ii) aliphatic, substituted aliphatic and arylalkyl monoperoxyacids, e.g. peroxylauric acid, peroxystearic acid, 4-nonylamino-4-oxoperoxybutyric acid, and N,N-phthaloylaminoperoxy caproic acid (PAP); and

(iii) 6-octylamino-6-oxo-caproic acid.

(iv) magnesium monoperoxophtalate hexahydrate, available from Interox.

(v) 6-nonylamino-6-oxoperoxycaproic acid (NAPAA)

(vi) Phtaloylimidoperoxycaproic acid

Typical diperoxyacids useful herein include, for example:

(vii) 1,12-diperoxydodecanedioic acid (DPDA);

(vii) 1,9-diperoxyazelaic acid;

(viii) diperoxytetradecanedioc acid

(ix) diperoxyhexadecanedioc acid

(x) diperoxybrassilic acid; diperoxysebasic acid and diperoxyisophthalic acid;

(xi) 2-decyldiperoxybutane-1,4-diotic acid; and

(xii) 4,4′-sulphonylbisperoxybenzoic acid.

Also inorganic peroxyacid compounds are suitable, such as for example potassium monopersulphate (MPS). If organic or inorganic peroxyacids are used as the peroxygen compound, the amount thereof will normally be within the range of about 2-10% by weight, preferably from 4-8% by weight.

Peroxyacid bleach precursors are known and amply described in literature, such as-in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are:

2-(N,N,N-trimethyl ammonium) ethyl -4-sulphonylcarbonate (CSPC); as disclosed in U.S. Pat. No. 4,751,015;

N-octyl-N,N-dimethyl-N10-carbophenoxy decyl ammonium chloride (ODC);

and N,N,N-trimethyl ammonium toluyloxy benzene sulphonate.

A further special class of bleach precursors is formed by the cationic nitrites as disclosed in EP-A-303,520 and in European Patent Specification Nos. EP-A-458,396 and EP-A-464,880.

Any one of these peroxyacid bleach precursors can be used in the present invention, though some may be more preferred than others.

Of the above classes of bleach precursors, the preferred classes are the esters, including acyl phenol sulphonates and acyl alkyl phenol sulphonates; the acyl-amides; and the quaternary ammonium substituted peroxyacid precursors including the cationic nitriles.

Examples of said preferred peroxyacid bleach precursors or activators are sodium-4-benzoyloxy benzene sulphonate (SBOBS); N,N,N′N′-tetraacetyl ethylene diamine (TAED); sodium-1-methyl-2-benzoyloxy benzene-4-sulphonate; sodium-4-methyl-3-benzoloxy benzoate; SSPC; trimethyl ammonium toluyloxy-benzene sulphonate; sodium nonanoyloxybenzene sulphonate (SNOBS); sodium 3,5,5-trimethyl hexanoyl-oxybenzene sulphonate (STHOBS); and the substituted cationic nitriles.

Each of the above precursor may be applied in mixtures, eg combination of TAED (hydrophylic precursor) with more hydrophobic precursor, such as sodium nonanoyloxybenzene sulphonate.

Alternatively, one may apply aromatic aldehydes and dioxygen as peroxy acid precursor, as disclosed in WO97/38074.

The precursors may be used in an amount of up to 12%, preferably from 2-10% by weight, of the composition.

Other classes of bleach precursors for use with the present invention are found in WO0015750 and WO9428104, for example 6-(nonanamidocaproyl)oxybenzene sulphonate. See WO0002990 for cylic imido bleach activators.

The precursors may be used in an amount of up to 12%, preferably from 2-10% by weight, of the composition.

The bleaching composition of the present invention has particular application in detergent formulations, especially for laundry cleaning. Accordingly, in another preferred embodiment, the present invention provides a detergent bleach composition comprising a bleaching composition as defined above and additionally a surface-active material, optionally together with detergency builder.

Also useful as bleaching agents in the compositions according to any aspect of the present invention are any of the known organic bleach catalysts, oxygen transfer agents or precursors therefor. These include the compounds themselves and/or their precursors, for example any suitable ketone for production of dioxiranes and/or any of the heteroatom containing analogs of dioxirane precursors or dioxiranes, such as sulfonimines R1R2C=NS02R3 (EP 446 982 A) and sulfonyloxaziridines, for example:

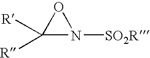

EP 446,981 A. Preferred examples of such materials include hydrophilic or hydrophobic ketones, used especially in conjunction with monoperoxysulfates to produce dioxiranes in situ, and/or the imines described in U.S. Pat. No. 5,576,282 and references described therein. Oxygen bleaches preferably used in conjunction with such oxygen transfer agents or precursors include percarboxylic acids and salts, percarbonic acids and salts, peroxymonosulfuric acid and salts, and mixtures thereof. See also U.S. Pat. No. 5,360,568; U.S. 5,360,569; U.S. Pat. No. 5,370,826; and U.S. Pat. No. 5,710,116.

Transition-metal bleach catalysts are well-known in the art. Various classes have been disclosed based on especially cobalt, manganese, iron and copper transition-metal complexes. Most of these bleach catalysts are claimed to yield hydrogen peroxide or peroxyacid activation, certain classes of compounds are also disclosed to give stain bleaching by atmospheric oxygen.

One type of manganese-containing bleach catalysts include the manganese-based complexes disclosed in U.S. Pat. No. 5,246,621 and U.S. Pat. No. 5,244,594. Preferred examples of theses catalysts include [Mn^{IV}₂(μ-O)₃(1,4,7-trimethyl-1,4,7-triazacyclononane)₂](PF₆)₂, [Mn^{III}₂(μ-O)(μ-OAc)₂(1,4,7-trimethyl-1,4,7-triazacyclononane)₂](ClO₄)₂, [Mn^{IV}₄(μ-O)₆(1,4,7-triazacyclononane)₄](ClO₄)₂, Mn^{III}Mn^{IV}(μ-O)(μ-OAc)₂(1,4,7-trimethyl-1,4,7-triazacyclononane)₂](ClO₄)₃, and mixtures thereof. See also European patent application publication no. 549,272. Other ligands suitable for use herein include 1,5,9-trimethyl-1,5,9-triazacyclododecane, 2-methyl-1,4,7-triazacyclononane, 2-methyl-1,4,7-trimethyl-1,4,7-triazacyclononane, and mixtures thereof. See also U.S. Pat. No. 5,194,416 which teaches mononuclear manganese (IV) complexes such as [Mn(1,4,7-trimethyl-1,4,7-triazacyclononane)(OCH₃)₃](PF₆). Patent applications EP0549271; DE19738273 teach the use of free ligand 1,4,7-trimethyl-1,4,7-triazacyclononane in detergent formulations. A dinuclear manganese compound, [LMn^{III}Mn^{IV}(μ-O)(μ-OAc)₂](ClO₄)₂ with L being an ethylene-bridged-bis(1,4-dimethyl-1,4,7-triazacyclononane) ligands has been disclosed in WO 9606154.

Still another type of bleach catalyst, as disclosed in U.S. Pat. No. 5,114,606, is a water-soluble complex of manganese (II), (III), and/or (IV) with a ligand which is a non-carboxylate polyhydroxy compound having at least three consecutive C—OH groups. Preferred ligands include sorbitol, iditol, dulsitol, mannitol, xylitol, arabitol, adonitol, meso-erythritol, meso-inositol, lactose, and mixtures thereof.

U.S. Pat. No. 5,114,611 teaches another useful bleach catalyst comprising a complex of transition metals, including Mn, Co, Fe, or Cu, with an non-(macro)-cyclic ligand. Preferred ligands include pyridine, pyridazine, pyrimidine, pyrazine, imidazole, pyrazole, and triazole rings. Optionally, said rings may be substituted with substituents such as alkyl, aryl, alkoxy, halide, and nitro. Particularly preferred is the ligand 2,2′-bispyridylamine. Preferred bleach catalysts include Co-, Cu-, Mn-, or Fe-bispyridylmethane and bispyridylamine complexes. Highly preferred catalysts include Co(2,2′-bispyridylamine)Cl₂, Di(isothiocyanato)bispyridylamine-cobalt(II), trisdipyridylamine-cobalt(II) perchlorate, [Co(2,2-bispyridylamine)₂O₂]ClO₄, Bis-(2,2′-bispyridylamine)copper(II) perchlorate, tris(di-2-pyridylamine) iron(II) perchlorate, and mixtures thereof.

Various manganese and iron complexes containing (pyridin-2ylmethyl)amine moieties as bleach catalysts are disclosed in DE19755493, EP0783035, U.S. Pat. No. 5,850,086, EP0782998, EP0782999, WO9748787, WO9730144, WO0027975, WO0027976, WO0012667, and WO00126.68. Preferred ligands include bis(CH₂COOH)(pyridin-2-ylmethyl)amine, tris(pyridin-2ylmethyl)amine, bis(pyridin-2-ylmethylamine), N,N,N′,N′-tetrakis(pyridin-2ylmethyl)-ethylenediamine, N,N,N′,N′-tetrakis(benzimidazol-2ylmethyl)-propan-2-ol, N-methyl-N,N′,N′-tris(3-methyl-pyridin-2ylmethyl)-ethylenediamine, N-methyl-N,N′,N′-tris(5-methyl-pyridin-2ylmethyl)-ethylenediamine, N-methyl-N,N-′,N′-tris(3-ethyl-pyridin-2ylmethyl)-ethylenediamine, N-methyl-N,N′,N′-tris(3-methyl-pyridin-2ylmethyl)-ethylenediamine.

A series of patent applications deal with iron complexes containing the bis(pyridin-2yl)methyl-amine moiety both for peroxy bleaching activation and atmospheric air bleaching of stains, i.e. WO9534628, EP0909809, WO0060044, WO0032731, WO0012667, and WO0012668, wherein the iron complexes containing N,N-bis(pyridin-2-yl-methyl)-1,1-bis(pyridin-2-yl)-1-aminoethane are often the most preferred catalysts.

Manganese complexes containing 1,10-phenanthroline and 2,2′-bipyridine as bleaching catalysts have been disclosed in WO9615136 and WO9964554.

Manganese complexes with Schiff-base ligands to bleach staihs or dyes in solution have been disclosed in various patent applications (GB-A-2 325 001, WO-A-00/53708, EP-A-896 171 WO-A-97/44430, WO-A-97/07191, and WO-A-97/07192).

Another preferred class of manganese complexes include mononuclear manganese complexes containing cross-bridged macrocyclic ligands. These complexes have been claimed with peroxy compounds and without peroxy compounds present in the formulation (WO-A-98/39098, WO-A-98/39405 and WO-A-00/29537). The most preferred complexes include dichloro-5,12-dimethyl-1,5,8,12-tetraazabicyclo[6.6.2]hexadecane Manganese(II)and dichloro-4,10-dimethyl-1,4,7,10-tetraazabicyclo[5.5.2]tetradecane Manganese(II).

Further a class of manganese complexes containing bispidon as ligand has been disclosed as a family of bleach catalysts in the presence and absence of peroxy compounds (WO0060045), wherein dimethyl 2,4-di-(2-pyridyl)-3,7-dimethyl-3,7-diaza-bicyclo[3.3.1]nonan-9one-1,5-dicarboxylate is the preferred ligand.

Other bleach catalysts are described, for example, in European patent application, publication no. EP-A-0 408,131 (dinuclear cobalt Schiff-base complex catalysts), European patent applications, publication nos. EP-A-384,503, and EP-A-306,089 (metallo-porphyrin catalysts), U.S. Pat. No. 4,711,748 and European patent application, publication EP-A-224,952, (absorbed manganese on aluminosilicate catalyst), U.S. Pat. No. 4,601,845 (aluminosilicate support with manganese and zinc or magnesium salt), U.S. Pat. No. 4,626,373 (manganese/ligand catalyst), U.S. Pat. No. 4,119,557 (ferric complex catalyst), German Pat. specification DE-A-2,054,019 (cobalt-1,10-phenanthroline catalyst), Canadian 866,191 (transition metal-containing salts), U.S. Pat. No. 4,430,243 (chelants with manganese cations and non-catalytic metal cations), and U.S. Pat. No. 4,728,455 (manganese gluconate catalysts).

Another class of preferred cobalt catalysts having the formula [Co(NH₃)₅Cl]Cl₂ has been disclosed in EP-A-0 272 030. Yet another class of preferred of cobalt (III) catalysts [Co(NH₃)₅(carboxylate)]X₂ (with X a non-coordinating anion), as disclosed in U.S. Pat. No. 580,001 and U.S. Pat. No. 508,198.

Inorganic polyoxometallates as bleaching/oxidation catalysts with peroxy bleaches and air have been claimed in various patent applications, i.e. WO-A-97/07886, WO-A-99/28426, DE-A-1 953 0786, and WO-A-00/39264.

The bleach catalysts may be used in an amount of up to 5%, preferably from 0.001-1% by weight, of the composition.

Chelating Agents

The compositions according to the present invention may also optionally contain one or more heavy metal chelating agents.

Generally, chelating agents suitable for use herein can be selected from the group consisting of aminocarboxylates, aminophosphonates, polyfunctionally-substituted aromatic chelating agents and mixtures thereof. Without intending to be bound by theory, it is believed that the benefit of these materials is due in part to their exceptional ability to remove heavy metal ions from washing solutions by formation of soluble chelates; other benefits include inorganic film or scale prevention. Other suitable chelating agents for use herein are the commercial DEQUESTO series, and chelants from Monsanto, DuPont, and Nalco, Inc.

Aminocarboxylates useful as optional chelating agents include ethylenediaminetetracetates, N-hydroxyethylethylenediaminetriacetates, nitrilotriacetates, ethylenediamine tetraproprionates, triethylenetetraaminehexacetates, diethylenetriamine-pentaacetates, and ethanoldiglycines, alkali metal, ammonium, and substituted ammonium salts therein and mixtures therein.

Aminophosphonates are also suitable for use as chelating agents in the compositions of the invention when at least low levels of total phosphorus are permitted in detergent compositions, and include ethylenediaminetetrakis (methylenephosphonates). Preferably, these aminophosphonates do not contain alkyl or alkenyl groups with more than about 6 carbon atoms.

Polyfunctionally-substituted aromatic chelating agents are also useful in the compositions herein. See U.S. Pat. No. 3,812,044. Preferred compounds of this type in acid form are dihydroxydisulfobenzenes such as 1,2-dihydroxy-3,5-disulfobenzene.

A chelator for use herein is ethylenediamine disuccinate (“EDDS”), especially (but not limited to) the [S,S] isomer as described in U.S. Pat. No. 4,704,233. The trisodium salt is preferred though other forms, such as magnesium salts, may also be useful.

If utilized these chelating agents or transition-metal-selective sequestrants will preferably comprise from about 0.001% to about 10%, more preferably from about 0.05% to about 1% by weight of the bleaching compositions herein.

Enzymes

Laundry-wash compositions according to the invention may also contain one or more enzyme(s). Suitable enzymes include the proteases, amylases, cellulases, oxidases, peroxidases and lipases usable for incorporation in detergent compositions. Preferred proteolytic enzymes (proteases) are, catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available and can be used in the instant invention. Examples of suitable proteolytic enzymes are the subtilisins which are obtained from particular strains of B. Subtilis B. licheniformis, such as the commercially available subtilisins Maxatase (Trade Mark), as supplied by Gist Brocades N.V., Delft, Holland, and Alcalase (Trade Mark), as supplied by Novo Industri A/S, Copenhagen, Denmark.

Particularly suitable is a protease obtained from a strain of Bacillus having maximum activity throughout the pH range of 8-12, being commercially available, e.g. from Novo Industri A/S under the registered trade-names Esperase (Trade Mark) and Savinase (Trade-Mark). The preparation of these and analogous enzymes is described in GB-A-1 243 785. Other commercial proteases are Kazusase (Trade Mark obtainable from Showa-Denko of Japan), Optimase (Trade Mark from Miles Kali-Chemie, Hannover, West Germany), and Superase (Trade Mark obtainable from Pfizer of U.S.A.).

Detergency enzymes are commonly employed in granular form in amounts of from about 0.1 to about 3.0 wt %. However, any suitable physical form of enzyme may be used.

Other Optional Minor Ingredients

The compositions of the invention may contain alkali metal, preferably sodium carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Powder flow may be improved by the incorporation of a small amount of a powder structurant, for example, a fatty acid (or fatty acid soap), a sugar, an acrylate or acrylate/maleate copolymer, or sodium silicate. One preferred powder structurant is fatty acid soap, suitably present in an amount of from 1 to 5 wt %.

Yet other materials that may be present in detergent compositions of the invention include sodium silicate; antiredeposition agents such as cellulosic polymers; inorganic salts such as sodium sulphate; lather control agents or lather boosters as appropriate; dyes; coloured speckles; perfumes; foam controllers; fluorescers and decoupling polymers. This list is not intended to be exhaustive.

Product Form

Compositions of the present invention may for example be provided as solid compositions such as powders or tablets, or non-solid compositions such as substantially aqueous or substantially non-aqueous liquids, gels or pastes. Optionally, liquid compositions may be provided in water soluble sachets. Non-solid, eg liquid, compositions may have different compositions from solid compositions and may for example comprise from 5% to 60%, preferably from 10% to 40% by weight of anionic surfactant (at least some of which will, of course, be aromaticalkyl sulphonic surfactant, from 2.5% to 60%, preferably from 5% to 35% by weight of nonionic surfactant and from 2% to 99% by weight of water. Optionally, liquid compositions may for example contain from 0.1% to 20%, preferably from 5% to 15% by weight of soap.

Non-solid, eg liquid, compositions may also (subject to any exclusions or other provisos expressed herein in the context of any aspect of the invention), comprise one or more hydrotropes, especially when an isotropic composition is required. Such hydrotropes may, for example, be selected from arylsulphonates, eg benzene sulphonate, any of which is optionally independently substituted on the aryl ring or ring system by one or more C₁₋₆ eg C₁₋₄ alkyl groups, benzoic acid, salicylic acid, naphthoic acid, C₁₋₆, preferably C₁₋₄ polyglucosides, mono-, di- and triethanolamine. Where any of these compounds may exist in acid or salt (whether organic or inorganic, such as sodium), either may be used provided compatible with the remainder of the formulation.

Preparation of the Compositions

The compositions of the invention may be prepared by any suitable process.

The choice of processing route may be in part dictated by the stability or heat-sensitivity of the surfactants involved, and the form in which they are available.

For granular products, ingredients such as enzymes, bleach ingredients, sequestrants, polymers and perfumes which are traditionally added separately (e.g. enzymes postdosed as granules, perfumes sprayed on) may be added after the processing steps outlined below.

Suitable Processes Include:

(1) drum drying of principal ingredients, optionally followed by granulation or postdosing of additional ingredients;

(2) non-tower granulation of all ingredients in a high-speed mixer/granulator, for example, a Fukae (Trade Mark) FS series mixer, preferably with at least one surfactant in paste form so that the water in the surfactant paste can act as a binder;

(3) non-tower granulation in a high speed/moderate speed granulator combination, thin film flash drier/evaporator or fluid bed granulator.

### EXAMPLES

### Composition Examples

wt %

| | Example | | | | | |
|---|---|---|---|---|---|---|
| | A | 1 | B | 2 | C | 3 |
| NaLAS | 11.81 | 0.00 | 11.81 | 0.00 | 11.81 | 7.88 |
| Soap | 1.79 | 1.79 | 1.79 | 1.79 | 1.79 | 1.79 |
| Nonionic EO5 | 3.94 | 3.94 | 3.94 | 3.94 | 3.94 | 3.94 |
| NaAASA | 0 | 11.81 | 0 | 11.81 | 0 | 3.94 |
| STP | 0 | 0 | 10.46 | 10.46 | 0 | 0 |
| Zeolite A24 | 20.92 | 20.92 | 10.46 | 10.46 | 10.46 | 10.46 |
| Na Carbonate | 13.07 | 13.07 | 13.07 | 13.07 | 13.07 | 13.07 |
| Copolymer | 1.11 | 1.11 | 1.11 | 1.11 | 1.11 | 1.11 |
| Builder | | | | | | |
| Na Sulphate | 10.3 | 10.3 | 10.3 | 10.3 | 10.3 | 10.3 |
| Na disilicate | 1.07 | 1.07 | 1.07 | 1.07 | 1.07 | 1.07 |
| Silicone | 1.25 | 1.25 | 1.25 | 1.25 | 1.25 | 1.25 |
| Antifoam | | | | | | |
| Fluorescer | 0.75 | 0.75 | 0.75 | 0.75 | 0.75 | 0.75 |
| Sodium | 4.25 | 4.25 | 4.25 | 4.25 | 4.25 | 4.25 |
| Carbonate | | | | | | |
| Na Silicate/ | 3.35 | 3.35 | 3.35 | 3.35 | 3.35 | 3.35 |
| Na Carbonate | | | | | | |
| Bleach | 0.66 | 0.66 | 0.66 | 0.66 | 0.66 | 0.66 |
| Stabilizer | | | | | | |
| Citric acid | 2.55 | 2.55 | 2.55 | 2.55 | 2.55 | 2.55 |
| TAED (83% | 2.75 | 2.75 | 2.75 | 2.75 | 2.75 | 2.75 |
| active) | | | | | | |
| Na | 13.25 | 13.25 | 13.25 | 13.25 | 13.25 | 13.25 |
| Percarbonate | | | | | | |
| Savinase 12.0 | 0.50 | 0.50 | 0.50 | 0.50 | 0.50 | 0.50 |
| TXT | | | | | | |
| Thermamyl | 0.33 | 0.33 | 0.33 | 0.33 | 0.33 | 0.33 |
| 60T | | | | | | |
| Carezyme | 0.21 | 0.21 | 0.21 | 0.21 | 0.21 | 0.21 |
| 900T | | | | | | |
| Water | bal. | bal. | bal. | bal. | bal. | Bal. |

“bal.” = balance

Comparative Data

The above compositions were tested for washing performance, dosed at 5.0 g/l in a solution at 40° C. at a water hardness of 20° French Hard with a Ca:Mg hardness ratio of 4:1. The wash time was 30 minutes. Compositions A, 1, C and 3 were tested on a polyester/cotton soiled with sunflower oil. Compositions B and 2 were tested on biro ink stain on cotton. The results were as follows:

Change (ΔE)

Example:

| | A | 1 | B | 2 | C | 3 |
|---|---|---|---|---|---|---|
| Run | | | | | | |
| 1 | 12.5 | 26.0 | 40.8 | 43.7 | 16.8 | 24.3 |
| 2 | 17.2 | 23.0 | 38.9 | 43.6 | 17.3 | 19.5 |
| 3 | 13.2 | 24.2 | 38.7 | 45.0 | 16.8 | 21.3 |
| 4 | 11.9 | 21.1 | 40.0 | 45.8 | 17.2 | 24.5 |
| Average | 13.7 | 23.6 | 39.6 | 44.6 | 17.0 | 22.4 |
| Standard | 2.4 | 2.1 | 1.0 | 1.1 | 0.3 | 2.4 |
| Deviation | | | | | | |

ΔE represents the change in lightness in the three dimensional colour space hue/saturation/lightness. The greater the number, the greater is the degree of stain removal.

Preparation of MLAS

The MLAS was made following WO 99/05084 (PCT/IB98/01097) EXAMPLE 2 (pg. 25). Specifically, it was prepared via an alcohol derived from a positionally nonselectively hydroformylated linear olefin. A 5 g sample of ISALCHEM 123(R) (ex ENICHEM) is added to a glass autoclave liner along with 70 ml of benzene and 1 g of a shape selective catalyst (solid form, acidic mordenite catalyst: Zeocat(R) FM-8/25H (ex ZEOCHEM) ). The glass liner is sealed inside a stainless steel autoclave. The autoclave is purged twice with 250 psig nitrogen, and than charged to 1000 psig nitrogen. With mixing, the mixture is heated to 180-200° C. overnight for 14-15 hours at which time it is then cooled and removed from the autoclave. The reaction mixture is filtered to remove catalyst and concentrated by evaporation of benzene using rotary evaporator to obtain a clear colorless or nearly colorless liquid product. The modified alkylbenzene mixture is then sulfonated with a molar equivalent of chlorosulfonic acid using methylene chloride as solvent. The methylene chloride is removed, the product neutralized with sodium methoxide in methanol and the methanol evaporated to give modified alkylbenzene sulfonate, sodium salt mixture.

C13 NMR measured: 58.3% on the mid-chain branching position, the other branches were distributed on the 2- and 3- and on the ω2-position.

| | Examples | Examples |
|---|---|---|
| | D, 4, E | F, 5, |
| | (wt %) | G (wt %) |
| Anionic | 8.89 | 8.89 |
| Nonionic EO7 | 6.95 | 6.95 |
| Zeolite A24 | 21.03 | 10.52 |
| Na-Carbonate | 13.54 | 13.54 |
| Copolymer Builder | 1.16 | 1.16 |
| Na-Sulphate | 10.79 | 10.79 |
| Na-DiSilicate | 1.12 | 1.12 |
| Soap | 1.69 | 1.69 |
| Antifoam | 1.30 | 1.30 |
| Antiredepositon | 0.20 | 0.20 |
| Polymer | | |
| Fluorescer (15%) | 0.85 | 0.85 |
| Na-carbonate | 2.99 | 2.99 |
| Na Silicate/Na | 3.15 | 3.15 |
| Carbonate | | |
| Bleach Stabiliser | 1.1 | 1.1 |
| Citric acid | 2.56 | 2.56 |
| TAED (83% active) | 2.75 | 2.75 |
| NaPercarbonate | 13.20 | 13.20 |
| Savinase 12.0 TXT | 0.52 | 0.52 |
| Thermamyl 60T | 0.33 | 0.33 |
| Carezyme 900T | 0.21 | 0.21 |
| Water | bal. | bal. |

Anionic in examples:
D: NaLAS,
4—NaAASA,
E—MLAS,
F: NaLAS,
5—NaAAASA,
G—MLAS

Comparative Data

ΔE values are as follows. Conditions: 5 g/l, 40° C. and 20° FH:

| | Example | | | | | |
|---|---|---|---|---|---|---|
| | D | 4 | E | F | 5 | G |
| Stain | Ink | Ink | Ink | Lipstick | Lipstick | Lipstick |
| Run 1 | 34.2 | 36.1 | 32.3 | 23.6 | 31.2 | 22.5 |
| Run 2 | 34.2 | 37.1 | 33.6 | 26.0 | 33.0 | 24.6 |
| run 3 | 29.9 | 34.3 | 30.3 | 24.2 | 31.8 | 24.8 |
| run 4 | 32.9 | 38.2 | 33.9 | 26.5 | 29.9 | 25.2 |
| Average | 32.8 | 36.4 | 32.5 | 25.1 | 31.4 | 24.3 |
| std. Dev | 2.0 | 1.6 | 1.6 | 1.4 | 1.3 | 1.2 |

Raw Material Specification

NaLAS—Dobanic Acid, C₁₀-C₁₃ alkylbenzene sulphonic acid sodium salt, ex shell, 95 wt % active.

MLAS—Mid-chain branched alkylbenzene sulphonate sodium salt (see preparation above).

Soap—hardened tallow fatty acid, Pristerene 4916 ex Uniqema.

Nonionic EO5—C₁₃-C₁₅ fatty alcohol ethoxylated with an average of 5 ethyleneoxide units per mole, Lutensol AO5 ex BASF.

Nonionic EO7—C₁₃-C₁₅ fatty alcohol ethoxylated with an average of 7 ethyleneoxide units per mole, Lutensol AO7 ex BASF.

NaAASA—Aryl (ie.benzene) C₁₄-C₁₆ alkyl sulphonic acid sodium salt prepared per Berger P. D., et al supra.

STP—sodium tripolyphosphate

Copolymer Builder—Sokalan CP5 Acrylate/Mateate (70:30) Copolymer Builder ex BASF.

Silicone antifoam—Adjunct granule containing 18 wt % active, ex Dow Corning.

Fluorescer—Adjunct granule, containing 17.5 wt % active whitening agent (Tinopal DMSX).

Na Silicate/Na Carbonate—Granule of sodium silicate and ex CIBA sodium carbonate (29 wt %/55 wt %), Nabion 15, ex Rhodia.

Bleach Stabilizer—ethylene diamine tetramethylene phosphonic acid Ca/Na salt, Dequest 2047, ex Monsanto.

TAED—Tetraacetylethylenediamine (80% active) ex Clariant

Savinase 12.0 TXT—protease enzyme, ex Novo

Thermamyl 60T—amylase enzyme, ex Novo

Carezyme 900T—cellulase enzyme, ex Novo

1. A detergent composition comprising from 0.01% to 99.9% by weight of an aromaticalkyl sulphonic surfactant, the balance being one or more other ingredients, other than:
(a) if the composition is a solid, then if it is a powder, it comprises a further surfactant in addition to the aromaticalkyl sulphonic surfactant(s) and other than a 10 mole ethoxylate of nonylphenol (preferably other than any nonylphenol ethoxylate); and
(b) if the composition is a non-solid then either
(1) it is substantially non-aqueous, preferably comprising 23% or less, more preferably 22% or less, still more preferably 20% or less, yet more preferably 15% or less, even more preferably 10% or less, especially 5% or less, 2% or less, or 1% or less by weight of water, eg substantially free from or completely free from water; or
(2) it is substantially aqueous and
(i) is substantially free from, or contains a hydrotrope additional to, sodium xylene sulphonate;
(ii) it is substantially free from, or contains an organic solvent additional to, the group consisting of ethanol and propylene glycol; and
(iii) has a pH≧6.5, preferably ≧7.

2. A composition according to claim 1, wherein the aromaticalkyl sulphonic surfactant is selected from those wherein:
i) the aromatic compound is selected from unsubstituted, mono-substituted or poly-substituted (e.g. di-substituted) monocyclic or polycyclic (e.g. bicyclic) aromatic compounds, preferably selected from benzene and naphthalene, each optional substituent preferably being selected from alkyl, (poly)alkoxylated alkyl and —OH; and
ii) the sulfonated alkyl group attached to the aromatic compound comprises an alkyl group selected from the group consisting of linear or branched alkyl groups of 7 to 30 carbon atoms, preferably from 8 to 24, more preferably from 9 to 20, still more preferably from 12 to 18, most preferably from 14 to 16 carbon atoms.

3. A composition according to claim 2, with the proviso that the aromatic compound is other than phenyl or napthalene.

4. A composition according to claim 2, wherein any group attached to each optional substituent in any mono- or poly- (eg di-) substituted aromatic compound is selected from linear and branched chain alkyl groups of 1 to 40, preferably 1 to 30, more preferably from 1 to 20, still more preferably from 1 to 10, and most preferably from 1 to 4 carbon atoms.

5. A composition according to claim 2, wherein any alkoxy group(s) optionally incorporated in any alkyl substituent on said aromatic compound are independently selected from ethylene oxide, propylene oxide, butylene oxide, and combinations of two or more thereof, where the number of alkoxylate groups range from 1 to 100.

6. A composition according to claim 2, wherein the aromaticalkyl sulphonic surfactant is selected from one or more compounds of formula (I): 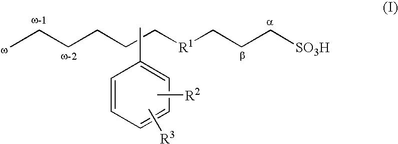
wherein R¹ is selected from straight and branched alkylene linkages having from 0 to 30, preferably from 1 to 20, more preferably from 2 to 15, still more preferably from 3 to 10, and most preferably from 5 to 7 carbon atoms. R² and R³ are independently hydrogen or methyl and preferably, the benzene ring is substituted to a substantial extent, eg up to 30 mole %, or up to 35% mole % or up to 40 mole % in the ω-1 or ω-2 position;
and/or salts thereof.

7. A composition according to claim 2, comprising from 0.1% to 65%, preferably from 2% to 30%, more preferably from 4% to 20%, especially from 5% to 15% by weight of the aromaticalkyl sulphonic surfactant.

8. A composition according to claim 1, comprising one or more anionic co-surfactants, the aromaticalkyl sulphonic surfactant constituting from 0.5% to 99.9%, preferably from 1% to 80%, more preferably from 10% to 60%, especially from 15% to 50%, more especially from 25% to 45% by weight of the total anionic surfactant content of the composition.

9. A composition according to claim 8, comprising from 0.1% to 70%, preferably from 1% to 40%, more preferably from 2% to 30%, especially from 3% to 20% of alkylbenzene sulphonic surfactant (in free acid and/or salt form).

10. A composition according to claim 1, comprising from 0.01% to 50%, preferably from 0.1% to 35%, more preferably from 0.5% to 25%, still more preferably from 0.7% to 20%, even more preferably from 0.8% to 15%, especially from 1% to 10% and even more especially from 1% to 7% by weight of the composition of nonionic surfactant.

11. A composition according to claim 1, comprising from 0.05% to 10%, preferably from 0.1% to 5%, more preferably from 0.25% to 2.5%, especially from 0.5% to 1% by weight of cationic surfactant.

12. A composition according to claim 1, comprising from 1% to 80%, preferably from 2% to 60%, more preferably from 4% to 30% by weight of the composition of detergency builder.
